(19) United States
(12) Patent Application Publication
(10) Pub. No.: US 2026/0125782 A1
(43) Pub. Date: May 7, 2026

(54) CAST IRON, IN PARTICULAR FOR COMPONENTS OF DISC BRAKES

(71) Applicant: Brembo S.p.A, Curno (IT)

(72) Inventors: Bozena DUDZIK, Curno (IT); Mariusz BIERONSKI, Curno (IT); Fabiano CARMINATI, Curno, Bergamo (IT)

(73) Assignee: Brembo S.p.A., Curno (IT)

(21) Appl. No.: 19/369,708

(22) Filed: Oct. 27, 2025

Related U.S. Application Data
(63) Continuation-in-part of application No. 17/628,935, now Pat. No. 12,473,617.

(30) Foreign Application Priority Data
Jul. 24, 2019 (IT) 102019000012738

(51) Int. Cl. C22C 37/08; C22C 37/10; F16D 65/12

(52) U.S. Cl. CPC C22C 37/08; C22C 37/10; F16D 65/125; F16D 2200/0013

(57) ABSTRACT

A gray cast iron comprising carbon, silicon, vanadium, manganese, nickel, chromium, molybdenum, copper, sulfur, phosphorus, tin and titanium, wherein: the percentage by weight of carbon is from 3.70-3.90%, the percentage by weight of silicon is from 1.30-2.10%, the percentage by weight of vanadium is from 0.12-0.14%, the percentage by weight of manganese is from 0.60-0.90%, the percentage by weight of nickel is from 0.05-0.50%, the percentage by weight of chromium is from 0.20-0.35%, the percentage by weight of molybdenum is not higher than 0.10%, the percentage by weight of copper is not higher than 0.35%, the percentage by weight of sulphur is lower than 0.10%, the percentage by weight of tin is lower than 0.10%, the percentage by weight of titanium is lower than 0.01%, the remainder by weight being constituted of iron.

### FIELD OF APPLICATION

The present invention relates to a cast iron, in particular for making a brake disc, and to a brake disc for a disc brake made with said cast iron.

### BACKGROUND ART

As known, brake discs made of gray cast iron are subject to wear at the braking bands over time. Inevitably, such phenomena affect the duration of the discs.

Therefore, the need to manufacture brake discs made of cast iron which have high wear resistance is greatly felt in the automotive field, and in particular for high-performance vehicles.

An increased wear resistance thus results in a reduction of metal powders being released into the environment.

However, the increased wear resistance in discs made of gray cast iron must be achieved taking into account the mechanical and thermal stresses of high intensity to which the brake discs are subjected. Such stresses result in the attainment of high temperatures on the braking bands, which can result in decreases in the braking performance, and even in the formation of cracks on the braking band.

The need is also felt for brake discs made of gray cast iron to have high corrosion resistance so as to increase the duration thereof. Therefore, increased wear resistance must not have a negative impact on the corrosion resistance.

In the art, gray cast iron solutions capable of simultaneously combining high wear resistance with high performance in terms of mechanical resistance, heat resistance, and corrosion resistance are not known.

### PRESENTATION OF THE INVENTION

It is the object of the present invention to provide a gray cast iron which overcomes the drawbacks stated with reference to the prior art.

Such drawbacks are overcome by a gray cast iron according to claim 1.

Other embodiments of the cast iron according to the invention are described in the following claims.

Further features and advantages of the present invention will become more apparent from the description given below of preferred, non-limiting embodiments thereof.

### DETAILED DESCRIPTION

According to a general embodiment, the gray cast iron of the present invention comprises in the alloy: carbon, silicon, vanadium, manganese, nickel, chromium, molybdenum, copper, sulfur, phosphorous, tin and titanium.

Such alloying elements are contained in the cast iron with the following ranges of percentage by weight on the total weight of the cast iron:
carbon from 3.70 to 3.90% by weight,
silicon from 1.30 to 2.10% by weight,
vanadium from 0.12 to 0.14% by weight,
manganese from 0.60 to 0.90% by weight,
nickel from 0.05 to 0.50% by weight,
chromium from 0.20 to 0.35% by weight,
molybdenum no more than 0.10% by weight,
copper no more than 0.35% by weight,
sulfur less than 0.10% by weight,
phosphorus less than 0.10% by weight,
tin less than 0.10% by weight,
titanium no more than 0.01% by weight,
the remainder by weight being iron.

Preferably, the percentage by weight of carbon is from 3.70 to 3.86%,

Preferably, the percentage by weight of silicon is from 1.40 to 2.08%,

Preferably, the percentage by weight of manganese is from 0.63 to 0.85%,

Preferably, the percentage by weight of nickel is from 0.06 to 0.47%.

Preferably, the percentage by weight of chromium is from 0.21 to 0.35%,

Preferably, the percentage by weight of copper is from 0.19 to 0.35%,

Preferably, the percentage by weight of tin is no more than 0.09%,

Preferably, the percentage by weight of titanium is from 0.0079 to 0.01%.

According to a first preferred embodiment, the gray cast iron has the following composition:
3.86% by weight carbon;
1.85% by weight silicon;
0.12% by weight vanadium;
0.63% by weight manganese;
0.06% by weight nickel;
0.21% by weight chromium;
0.002% by weight molybdenum;
0.19% by weight copper;
0.065% by weight sulfur;
0.04% by weight phosphorous;
0.023% by weight tin;
0.0079% by weight titanium;
the remainder by weight being iron.

According to a second preferred embodiment, the gray cast iron has the following composition:
3.70% by weight carbon;
2.08% by weight silicon;
0.12% by weight vanadium;
0.658% by weight manganese;
0.47% by weight nickel;
0.255% by weight chromium;
0.0312% by weight molybdenum;
0.238% by weight copper;
0.0463% by weight sulfur;
0.031% by weight phosphorous;
0.038% by weight tin;
0.01% by weight titanium;
the remainder by weight being iron.

Advantageously, the gray cast iron can additionally comprise tungsten, with a percentage by weight from 0.10 to 0.14%, and preferably equal to 0.12%.

According to a third particularly preferred embodiment, the gray cast iron has the following composition:
3.75% by weight carbon,
1.40% by weight silicon,
0.14% by weight vanadium;
0.12% by weight tungsten,
0.85% by weight manganese,
0.1% by weight nickel,
0.35% by weight chrome,
0.1% by weight molybdenum,
0.35% by weight copper,
<0.1% by weight sulfur,
<0.1% by weight phosphorous,
0.09% by weight tin,
0.01% by weight titanium
the remainder by weight being iron.

Preferably, the ferrous matrix of the cast iron is of the pearlite or fine lamellar type. In particular, the percentage by weight of pearlite on the weight of the ferrous matrix is no less than 95%.

Preferably, the gray cast iron comprises ferrite with a percentage by weight of less than 5% on the weight of the ferrous matrix. Even more preferably, the percentage by weight of ferrite on the weight of the ferrous matrix is equal to 1%.

In particular, the gray cast iron comprises cementite and free carbides with a percentage by weight of no more than 1% on the weight of the ferrous matrix.

Advantageously, the cast iron of the present invention can be used to produce components of disc brakes.

For example, the cast iron can be used to produce at least one braking band of a brake disc for a disc brake of any type.

Experimental wear tests have been carried out, comparing a brake disc made of a gray cast iron of a standard composition to three brake discs made of three cast irons, having three different compositions falling within the present invention. Further testing was done to study just the effect that different weight percentages of vanadium (hereinafter “V”) had on the wear-resistance of the cast iron.

### Comparative Example

A brake disc was obtained with a gray cast iron having the following composition: 3.74 by weight carbon; 1.65% by weight silicon; 0.55% by weight manganese; 0.1% by weight nickel; 0.15% by weight chromium; 0.1% by weight molybdenum; 0.2% by weight copper; <0.1% by weight sulfur; <0.08% by weight phosphorus; 0.023% by weight tin; 0.09% by weight titanium; the remainder by weight being iron.

The ferrous matrix consists of 1% by weight ferrite, 98.5% by weight pearlite and 0.5% by weight carbides.

The brake disc made of such a gray cast iron will be referred to as COMPARATIVE DISC below.

### Example 1

A first brake disc was obtained, identical to the comparative disc, but using a gray cast iron according to the invention, having the following first composition: 3.86% by weight carbon; 1.85 by weight silicon; 0.12% by weight vanadium; 0.63% by weight manganese; 0.06% by weight nickel; 0.21% by weight chromium; 0.002% by weight molybdenum; 0.19% by weight copper; 0.065% by weight sulfur; 0.04% by weight phosphorus; 0.023% by weight tin; 0.0079% by weight titanium; the remainder by weight being iron.

The ferrous matrix consists of 1% by weight ferrite, 98% by weight pearlite and 1% by weight carbides.

The brake disc made of such a gray cast iron will be referred to as DISC 1 below.

### Example 2

A second brake disc was obtained, identical to the comparative disc, but using a gray cast iron according to the invention, having the following second composition: 3.70% by weight carbon; 2.08% by weight silicon; 0.12% by weight vanadium; 0.658% by weight manganese; 0.47% by weight nickel; 0.255% by weight chromium; 0.0312% by weight molybdenum; 0.238% by weight copper; 0.0463% by weight sulfur; 0.031% by weight phosphorus; 0.038% by weight tin; 0.01% by weight titanium; the remainder by weight being iron.

The ferrous matrix consists of 1% by weight ferrite, 98% by weight pearlite and 1% by weight carbides.

The brake disc made of such a gray cast iron will be referred to as DISC 2 below.

### Example 3

A third brake disc was obtained, identical to the comparative disc, but using a gray cast iron according to the invention, having the following third composition: 3.75% by weight carbon; 1.40% by weight silicon; 0.14% by weight vanadium; 0.12% by weight tungsten; 0.85% by weight manganese; 0.1% by weight nickel; 0.35% by weight chromium; 0.1% by weight molybdenum; 0.35% by weight copper; <0.1% by weight sulfur; <0.1% by weight phosphorus; 0.09% by weight tin and 0.01% by weight titanium; the remainder by weight being iron.

The ferrous matrix consists of about 1% by weight ferrite, 97.5% by weight pearlite and <1% by weight carbides.

The brake disc made of such a gray cast iron will be referred to as DISC 3 below.

### Experimental Tests

The comparative brake disc and the three brake discs according to the invention (DISC 1, 2 and 3) were subjected to five repetitions of a well-known technical test in the field of braking systems. At the end of such a test, it emerged that the reduction in weight loss of the three discs is from 50+55% as compared to the reference disc.

It emerges from such tests that, under equal conditions, the brake discs according to the invention (disc 1, 2 and 3) experienced a significantly smaller weight loss than that experienced by the comparative disc. On average, the brake discs according to the invention (disc 1, 2 and 3) had a weight loss of less than 50% as compared to that of the comparative disc.

This means that the gray cast irons according to the invention offer a greater wear resistance than the standard gray cast iron taken as reference.

From an analysis of the test results, it also emerges that disc 3 had a more marked reduction in weight loss than the comparative disc. From this it follows that the gray cast iron used to make such a disc 3 allows to obtain a more marked wear resistance.

The same brake discs (comparative disc, disc 1, disc 2 and disc 3) were further characterized from a mechanical point of view and of the functional parameters.

The results are shown in Table 1:

TABLE 1

| | COMPARATIVE | DISC | DISC | DISC |
|---|---|---|---|---|
| | DISC | 1 | 2 | 3 |
| Tensile | 190 | 182 | 165 | 273 |
| strength Rm | | | | |
| [MPa] | | | | |
| Hardness [HBW] | 180-186 | 187-190 | 183-185 | 234 |
| Density | 7.1 | 7.1 | 7.1 | 7.3 |
| [kg/dm³] | | | | |
| Corrosion [% | 0.29 | 0.21 | 0.23 | 0.17 |
| loss by weight] | | | | |

From a comparison of the data shown in Table 1, it emerges that, in terms of mechanical resistance, heat resistance and corrosion resistance, the performance of discs 1, 2 and 3 is substantially comparable to that of the brake disc created using a standard gray cast iron.

All this is also indirectly confirmed by the fact that, with respect to the standard gray cast iron used to make the comparative disc, the gray cast iron according to the invention does not involve any significant change in the percentages by weight of carbon (graphite), silicon, and in the sum of the percentages by weight of chromium and molybdenum.

The large amount of carbon (graphite) ensures that the cast iron according to the invention has a high thermal conductivity, which allows a high heat exchange during the braking shocks. Thereby, the risk of cracking due to thermal stress is significantly reduced, even after a heavy use of the braking system. The cast iron of the present invention also has a high damping capacity which contributes to increasing the resistance to the formation and spreading of cracks.

Due to the percentages of silicon included in the cast iron of the present invention, a graphitizing effect is achieved, preventing the formation of cementite and carbides.

Furthermore, chromium and molybdenum stabilize the formation of lamellar pearlite in the metal matrix.

At the end of the five repetitions of the standard test used during the design of suitable brake discs for the braking systems, the weight losses of the pads used in association with the comparative disc and with discs 1, 2 and 3 were then also measured.

From a data comparison, it emerges that discs 1, 2 and 3 cause a wear on the pads, which is substantially comparable to that caused by the comparative disc. Thus, the increase in the wear resistance does not cause an increase in the wear of the pads associated with the disc made using the cast iron according to the invention.

As can be appreciated from the description, the gray cast iron of the present invention allows the drawbacks presented in the prior art to be overcome.

In particular, the cast iron according to the present invention and the related brake discs made of said cast iron offer a significantly greater wear resistance than the standard gray cast iron, taken as reference. Such an increase does not result in a deterioration of mechanical resistance, heat resistance, and corrosion resistance.

In fact, the performance of brake discs made of the gray cast iron according to the invention is comparable to that of the brake disc made of a standard gray cast iron in terms of mechanical resistance, heat resistance, and corrosion resistance.

It also emerged that the increase in wear resistance ensured by the gray cast iron according to the invention does not significantly alter the wear of the pads either. In fact, from the data deriving from the weight losses, it emerges that the pads associated with discs 1, 2 and 3 were substantially worn in a similar manner (in terms of weight loss) to those associated with the comparative disc. In particular, compared to the comparative disc, there is indeed a reduction in the wear of the pads in the case of disc 3.

Further testing was performed regarding the percent by weight of Vanadium (hereinafter “V”) and the effect it had on the wear resistance of the gray cast iron. The test results are shown below in Tables 2 and 3. The data shown in Tables 2 and 3 are compared in Table 4.

Table 2 shows test results from a Pin-On-Disc analysis for gray cast iron with different weight percentages of V. A Pin-on-Disc test refers to a test used to measure friction, wear rates, and surface interactions under controlled sliding contact. A stationary pin presses against a rotating disc under a defined load while frictional force and wear volume are recorded.

The test examined how much mass, represented as a percent and relative to a comparative sample, was lost along a 5000 m long path given different weight percentages of V. The comparative example comprises 0% V and saw a loss of 7.9 grams along a path of 5000 m. Another sample used a gray cast iron with a weight percentage of 0.18% V and saw a loss of 14.3 grams of mass along a path of 5000 m, which was a loss of 81% more than the comparative example. Another example used a gray cast iron with a weight percentage of 0.08% V and saw a loss of 6.1 grams along a path of 5000 m, which was a loss of 22.8% less than the comparative example.

From these tests, it is clear that the weight percentage of V in the gray cast iron plays a significant role in how much mass is lost, and thus resistance to wear.

TABLE 2

| | MASS LOST (g) | % MASS LOST |
|---|---|---|
| | (Pin-On-Disk | IN |
| | Test on a | REFERENCE TO |
| | path of | COMPARATIVE |
| SAMPLE | 5000 m) | CAST-IRON |
| V 0.18% | 14.3 | +81% |
| V 0% (comparative example) | 7.9 | 0% |
| V 0.08% | 6.1 | -22.8% |

Table 3 shows data from a test that analyzed wear resistance of a grey cast iron with percentage by weight of V of 0%, 0.12%, 0.12%, and 0.14%. The test examined how much mass, represented as a percentage and relative to a comparative sample was lost during an LACT test given the different weight percentages of V. An LACT test may be understood to mean a test that simulates on a brake dynamometer the real stresses of a brake system over taxi routes in Los Angeles. The test consists in a long series of stops (ca 3500 brake applications) in 24-48-hours schedule applied on the disc under test.

The comparative example in this test comprises 0% V and saw a loss of 4.92 grams. Next, a gray cast iron with a V weight percentage of 0.12 was tested and saw a loss of 2.25 grams, which was a loss of 54.3% less than that of the comparative example. Another gray cast iron with a weight percentage of V of 0.12% was tested, and showed similar results, losing 2.4 grams, which was a loss of 51.2% less than that of the comparative example. Finally, a gray cast iron with a weight percentage of 0.14% V was tested and saw a loss of 2.15 grams, which was a loss of 56.3% less than that of the comparative sample.

TABLE 3

| | | % MASS LOST |
|---|---|---|
| | | REFERRED TO |
| | MASS LOST (g) | COMPARATIVE |
| SAMPLE | (LACT test) | CAST-IRON |
| V-0.12% (example 1) | 2.25 | -54.3% |
| V-0.12% (example 2) | 2.4 | -51.2% |
| V 0.14% (example 3) | 2.15 | -56.3% |
| V 0% (comparative example) | 4.92 | 0% |

Table 4 shows the results of the tests described in Tables 2 and 3 in different presentations. From Table 4, it can be appreciated that under the typical stress experienced by a brake pad, a grey cast iron with a weight percentage of V from between 0.12-0.14% has a higher wear resistance than a grey cast iron with a weight percentage of V outside of the 0.12-0.14% range. Put differently, grey cast irons with weight percentages of V lower than 0.12% and greater than 0.14% have a lower wear-resistance than grey cast irons with weight percentages of V within the 0.12-0.14% range. Put differently yet again, grey cast irons resist wear less when the weight percentage of V is below 0.12%, and the grey cast irons resist wear less when the weight percentage of V is above 0.14%.

TABLE 4

| | | | | |
|---|---|---|---|---|
| V[%] | 0.08 | 0.12 | 0.14 | 0.18 |
| Mass loss w/ respect to | -22.80 | -52.75 | -56.30 | 81.00 |
| reference (V = 0%) [%] | | | | |

As can be appreciated from table 4, a grey cast iron with V at a weight percentage of 0.08% resists wear 25%-50% less than a grey cast iron with V at a weight percentage of 0.12-0.14%. Similarly, a grey cast iron with V at a weight percentage of 0.18% resists wear at least 50% less than a grey cast iron with V at a weight percentage of 0.12-0.14%.

Given the above data, it is clear that a grey cast iron with V at a weight percentage of 0.12-0.14% far outperforms, in terms of wear resistance, grey cast iron with a weight percentage of V even slightly outside of the 0.12-0.14% range.

In accordance with the provisions of the patent statutes, the present device and/or method has been described in what is considered to represent its preferred embodiments. However, is should be noted that the present device and/or method can be practiced otherwise than as specifically illustrated and described without departing from its spirit or scope.

What is claimed is:

1. A grey cast iron comprising carbon, silicon, vanadium, manganese, nickel, chromium, molybdenum, copper, sulphur, phosphorus, tin and titanium, wherein
the percentage by weight of carbon is from 3.70-3.90%,
the percentage by weight of silicon is from 1.30-2.10%,
the percentage by weight of vanadium is from 0.12-0.14%
the percentage by weight of manganese is from 0.60-0.90%,
the percentage by weight of nickel is from 0.05-0.50%,
the percentage by weight of chromium is from 0.20-0.35%,
the percentage by weight of molybdenum is not higher than 0.10%
the percentage by weight of copper is not higher than 0.35%,
the percentage by weight of sulphur is lower than 0.10%,
the percentage by weight of tin is lower than 0.10%,
the percentage by weight of titanium is lower than 0.01%,
the remainder by weight being constituted of iron.

2. The grey cast iron of claim 1, wherein the percentage by weight of carbon is from 3.70 to 3.86%.

3. The grey cast iron of claim 1, wherein the percentage by weight of silicon is from 1.40 to 2.08%.

4. The grey cast iron of claim 1, wherein the grey cast iron has a higher wear resistance with a weight percentage of vanadium from 0.12-0.14% than with a weight percentage of vanadium outside of 0.12-0.14%.

5. The grey cast iron of claim 1, wherein the grey cast iron has a lower wear resistance with a weight percentage of vanadium lower than 0.12% and higher than 0.14%.

6. The grey cast iron of claim 1, wherein the grey cast iron resists wear less when the weight percentage of V is below 0.12%.

7. The grey cast iron of claim 1, wherein the grey cast iron resists wear 25-50% less when vanadium equals 0.08% compared to when vanadium equals 0.12-0.14%.

8. The grey cast iron of claim 1, wherein the grey cast iron resists wear at least 50% less when vanadium equals 0.18% compared to when vanadium equals 0.12-0.14%.

9. The grey cast iron according to claim 1, wherein the percentage by weight of manganese is from 0.63 to 0.85%.

10. The grey cast iron according to claim 1, wherein the percentage by weight of nickel is between 0.06 and 0.47%.

11. The grey cast iron according to claim 1, wherein the percentage by weight of chromium is between 0.21 and 0.35%.

12. The grey cast iron according to claim 1, wherein the percentage by weight of titanium is between 0.0079 and 0.01%.

13. The grey cast iron according to claim 1, consisting of 3.86% by weight of carbon, 1.85% by weight of silicon, 0.12% by weight of vanadium, 0.63% by weight of manganese, 0.06% by weight of nickel, 0.21% by weight of chromium, 0.002% by weight of molybdenum, 0.19% by weight of copper, 0.065% by weight of sulphur, 0.04% by weight of phosphorus, 0.023% by weight of tin, and 0.0079% by weight of titanium, the remainder by weight being iron.

14. The grey cast iron according to claim 1, consisting of 3.70% by weight of carbon, 2.08% by weight of silicon, 0.12% by weight of vanadium, 0.658% by weight of manganese, 0.47% by weight of nickel, 0.255% by weight of chromium, 0.0312% by weight of molybdenum, 0.238% by weight of copper, 0.0463% by weight of sulphur, 0.031% by weight of phosphorus, 0.038% by weight of tin and 0.01% by weight of titanium, the remainder by weight being iron.

15. The grey cast iron according to claim 1, further comprising tungsten, wherein the weight percentage of tungsten is between 0.10 and 0.14%.

16. The grey cast iron according to claim 1, wherein a matrix of said grey cast iron is pearlitic, wherein the percentage by weight of perlite is not lower than 95%.

17. The grey cast iron according to claim 1, comprising ferrite in a percentage by weight lower than 5%.

18. The grey cast iron according to claim 1, comprising cementite and free carbides with a percentage by weight not higher than 1%.

19. A brake disc for a disc brake comprising a braking surface made in a cast iron according to claim 1.

20. A grey cast iron consisting of carbon, silicon, vanadium, manganese, nickel, chromium, molybdenum, copper, sulphur, phosphorus, tin and titanium, wherein
the percentage by weight of carbon is from 3.70-3.90%,
the percentage by weight of silicon is from 1.30-2.10%,
the percentage by weight of vanadium is from 0.12-0.14%
the percentage by weight of manganese is from 0.60-0.90%,
the percentage by weight of nickel is from 0.05-0.50%,
the percentage by weight of chromium is from 0.20-0.35%,
the percentage by weight of molybdenum is not higher than 0.10%
the percentage by weight of copper is not higher than 0.35%,
the percentage by weight of sulphur is lower than 0.10%,
the percentage by weight of tin is lower than 0.10%,
the percentage by weight of titanium is lower than 0.01%,
the remainder by weight being constituted of iron.
